(19) United States
(12) Patent Application Publication
(10) Pub. No.: US 2009/0000596 A1
(43) Pub. Date: Jan. 1, 2009

(54) E85 Vehicle Compatibility Kit

(76) Inventor: Paul Spivak, Mayfield Village, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 11/771,328

(22) Filed: Jun. 29, 2007

(51) Int. Cl. F02D 41/30

(52) U.S. Cl. 123/445

(57) ABSTRACT

The present invention relates generally to an E85 vehicle compatibility kit and, more specifically, to a conversion kit provided as a means to make gasoline powered vehicles E85 compatible. The instant abstract is neither intended to define the invention disclosed in this specification nor intended to limit the scope of the invention in any way.

### RELATED APPLICATIONS

The present application claims the benefit of the filing date of Mar. 28, 2007 for U.S. Provisional Patent No. 60/______ for the purposes of priority, and incorporates the subject matter disclosed therein as if fully rewritten herein

### BACKGROUND OF THE INVENTION

1. Field of the Invention

The present invention relates generally to an E85 vehicle compatibility kit and, more specifically, to a conversion kit provided as a means to make gasoline powered vehicles E85 compatible.

2. Description of the Related Art

There are currently six million vehicles in the United States that are E85 compatible, that is, they can be powered by a motor fuel blend of 85% ethanol and 15% gasoline. E85 is a non-toxic alternative fuel that reduces pollution because it burns cleaner, degrades quickly and it is completely renewable. Besides its environmental benefits, E85 also attracts consumers because it is a domestic product that combats the rising costs of gasoline.

While some automobile manufacturers manufacture newer vehicles to comprise fuel systems that recognize a petroleum-based fuel verses an ethanol-based fuel, a number of automobiles, especially older ones, do not comprise a system. A computer module comprised on a gasoline powered vehicle activates the check engine light when it reads the higher amounts of oxygen verses gasoline in E85. The computer module comprised on an E85 powered vehicle can distinguish and read the higher amount. Another distinction between the two is that the fuel system in an E85 powered vehicle is also modified to be ethanol-compatible.

The present invention is an E85 compatibility kit that can be installed into the fuel systems of any of the 237 million gasoline powered automobiles on the road today to provide a safe and an effective means for the non-E85 compatible automobiles to run on E85 fuel. A search of the prior art revealed no references that teach the elements of the present claims; however, the Method and System for Adjusting Electronic Fuel Injection for Multiple Fuel Types disclosed in U.S. Ser. No. ______ to the present inventor is related. The internal combustion engine system disclosed in ('XXX) is configured to operate on multiple fuel types, including petroleum-based fuels and gasoline-type biofuels. The present invention comprises the Pulse Modifier taught in ('XXX), which is interposed between an engine computer module and a fuel injector, and a fuel filter assembly installed into a petroleum-based fuel tank. The filter assembly provides a means to filter the collected moisture accumulated in the tank so that the automobile is adapted to alternatively run as an E85 power system.

### SUMMARY OF THE INVENTION

It is an object of the present invention to provide a means for a gasoline powered vehicle to be E85 compatible. It is an object of the present invention to disclose a kit that comprises all the components necessary to adapt the vehicle to run on ethanol-based fuels without having to modify the existing fuel delivery system. It is an object that the components of the present kit work in conjunction with the existing computer module and the existing fuel tank to read the higher amounts or oxygen present in the E85 fuel.

It is an object of the present invention to include a controller with the kit so that the existing computer module, i.e., the engine control module (ECU) will not activate the check engine light. It is an object that the controller is able to read and to distinguish between the petroleum and the ethanol based fuels based on the levels of oxygen and gasoline present. It is an object that the present controller will reconfigure the engine control module to produce a more appropriate pulse width signal for the anticipated fuel blend.

It is an object of the present kit to also include a means to filter the excess moisture that is attracted by the E85 fuel and collected in the fuel tank. It is an object of the present means to prevent the accumulation of additional water in the fuel system so that components of the fuel system do not rust. It is envisioned that the present means includes a filter or a combination similar to that known in the art for the marine and the other engines that run on diesel fuels.

It is an object of the present invention that the water separator can simply be injected into the fuel tank of a vehicle. It is a further object of the present invention to include a pulse modifier interposed between the ECU and the fuel injectors. It is envisioned that the pulse modifier can be modified to the existing system in one service trip to a mechanic or manually.

It is another object of the present invention to not eliminate the option of selectively utilizing petroleum based fuels at the times when it can be more advantageous.

It is a final object of the present invention to provide all of the advantages to the environment and to the consumer entailed in the use of E85 fuels.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates the portions of an alternative fuel injector system comprised with a pulse modifier in the PRIOR ART; and,

FIG. 2 illustrates the compatibility kit according to the preferred embodiment of the present invention, wherein the kit comprises both the alternative fuel injector system shown in FIG. 1 and a fuel filter assembly.

### DESCRIPTION OF THE PREFERRED EMBODIMENTS

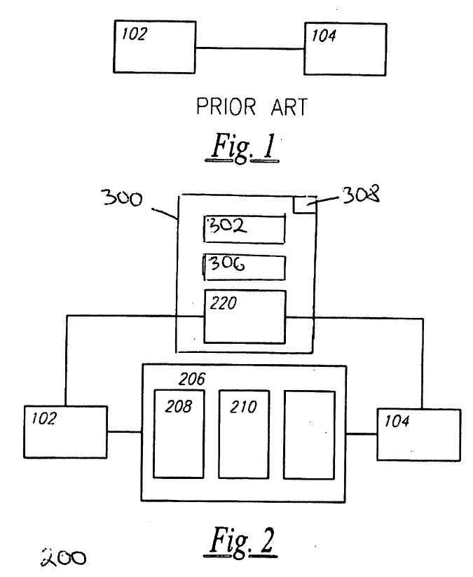

In order to describe the complete relationship of the invention, it is essential that some description be given to the manner and to the practice of the fuel injector system comprised on gasoline powered automobiles. FIG. 1 illustrates an alternative fuel injector system according to the PRIOR ART, wherein a Pulse Modifier 206 interposed between an in communication with an engine control unit (ECU) 102, sometimes referred to as an Engine Control Module (ECM) or a Powertrain Control Unit/Module (PCU, PCM), and an automobile fuel injector component 104. The fuel injector component 104 comprises a plurality of electronically controlled valves configured to open and to close many times per second. The amount of fuel supplied to the engine is determined by the amount of time the fuel injector 104 stays open, called the “pulse width” which is controlled by ECU 102 pulse width signals. The ECU 102 pulse width signals control the amount and the rate of fuel injected into each engine combustion chamber, and thereby control the combustion chamber air-fuel ratio (AFR), i.e., the mass ration of air to fuel present during combustion. Each fuel has a preferred AFR or a range of AFR's which achieve optimal fuel combustion when ignited. Problems arise if the ECU 102 is used with alternative fuels because the fuels generate lower energy than gasoline fuel blends, and thus higher pulse widths are required to generate comparable engine performances under similar operating parameters.

The Pulse Modifier 206 modifies the ECU 102 pulse width signals to enable the fuel injectors 104 to efficiently operate on one or more alternative fuels. The Pulse Modifier 206 may be configured by an after-market retailer and subsequently re-programmed to provide optimal fuel injector settings for one or more specified alternative fuels. The Pulse Modifier 206 is manually adjusted through a manual adjustment means 208, s.a., an analog dial-type switch, to increase or to decrease the amount of the pulse width when observed engine performance, automobile user preference or other requirements indicate a richer or a leaner alternative-fuel oxidizer ratio.

The Pulse Modifier 206 enables a conventional automobile to use either conventional gasoline or one or more alternative fuels by operation of the switch means 210 within the Pulse Modifier 206. The switch 210 is toggled to place the Pulse Modifier 206 in an inactive mode to use a conventional gasoline blend, wherein the Pulse Modifier 206 passes the ECU 102 pulse width signals directly to the fuel injectors 104 without modification. The switch 210 is toggled to place the Pulse Modifier 206 in an active mode when an alternative fuel is used, wherein the Pulse Modifier 206 modifies the ECU 102 pulse width signals and sends the signals to the fuel injectors 104.

### 1. Detailed Description of the Figures

The alternative fuel injector system described for FIG. 1 incorporates the Pulse Modifier 206 into a gasoline powered automobile to provide a means for its operator to switch back and forth between gasoline and alternative fuel-types; however, the PRIOR ART comprises no means to prevent the rust to the fuel system components caused by the accumulation of water that results from the E85's tendency to attract moisture when the alternative fuel mode is selected. The present invention kit improves the alternative fuel injector system because it provides a filter assembly 300 that works in conjunction with the Pulse Modifier 206.

A kit according to the present invention is shown in FIG. 2. The kit comprises the fuel injector system 200 in the prior art, which is after-market installed into a vehicle. The kit further comprises a fuel filter 300 capable of fuel-water separation. The fuel filter assembly 300 is similar to the ones commonly used with diesel fuel injection systems, but it is designed for installation in gasoline powered fuel tanks. The fuel filter assembly 300 is in no way limited to the one disclosed, but preferably comprises an easily accessible fuel filter cartridge 302 to separate water, a fuel transfer pump 304 to push fuel through the filter element 302, a sensor 306 to determine the level of accumulated water collected by the filter 302 and a means to drain 308 the accumulated water.

It is important that an alternative fuel injector system 200 not be installed in a vehicle independent of a fuel filter assembly 300. Similarly, it is not necessary that a fuel filter assembly 300 be installed in a gasoline powered vehicle not adapted, by means of the Pulse Modifier 206, to run on E85 fuel. Because the system 200 and the fuel assembly 300 must both be installed in a conventional gasoline powered vehicle to make it E85 compatible, a kit that comprises the both is a favorable means to advance the interests of the consumer because it obviates any risks that a system 200 sold independent of an assembly 300 will not work in conjunction. More specifically, it eliminates any risk that a consumer may mistakenly purchase a fuel tank assembly designed to separate, for example, water from the fuel in a marine tank powered by diesel. The present kit may be presented to consumers for manual installation or it may be made available at service shops for a mechanic's installation.

### 2. Operation of the Preferred Embodiment

To use the present kit, the Pulse Modifier comprised in the alternative fuel injector system, made part of the kit, is installed between the Engine Control Unit and the fuel injector of a conventional gasoline powered vehicle. The Pulse Modifier is activated when E85 fuel is desired by means of a switch element presented with the system. Similarly, a fuel filter assembly, made part of the kit, is removably installed in the fuel tank to separate the water accumulated in the tank. The fuel filter assembly eliminates the risks of rust build-up in the fuel systems of gasoline powered vehicles after-market adapted to be E85 compatible.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A kit to make gasoline powered vehicles E85 compatible, said kit comprises, in combination:
an alternative fuel injector system; and
a filter fuel assembly for separating water from fuel,
wherein said alternative fuel injector system comprises:
an engine control unit configured to provide a fuel injector pulse width signal;
a signal modifier in communication with said engine control unit, said signal modifier modifies the pulse width signal to generate an optimized, modified pulse width signal;
a switch comprised on said signal modifier; and
a fuel injector component in communication with said signal modifier;
wherein said signal modifier activates upon selection of said switch to provide said modified pulse width signal to said fuel injector component when an alternative fuel is used.

2. (canceled)

3. The kit of claim 1, wherein said alternative fuel injector system further comprises a manual means to adjust said modified pulse width, said means is configured to increase and to decrease said pulse width.

4. The kit of claim 1, wherein said fuel filter assembly is after-market installed into the fuel tank of said gasoline powered vehicle.

5. The kit of claim 1, wherein said fuel filter assembly comprises:
a fuel filter cartridge to separate water;
a fuel transfer pump to push fuel through said fuel filter cartridge;
a sensor to determine the level of accumulated water collected by said fuel filter cartridge; and,
a means to drain said accumulated water.
